(19) United States
(12) Patent Application Publication
(10) Pub. No.: US 2003/0201876 A1
(43) Pub. Date: Oct. 30, 2003

(54) School bus emergency exit monitor

(76) Inventors: Jeffrey James Stegman, Cincinnati, OH (US); Robert Clifford Green, Harrison, OH (US)

Correspondence Address: GRAYDON HEAD AND RITCHEY LLP, 1900 FIFTH THIRD CENTER, 511 WALNUT STREET, CINCINNATI, OH, 45202, US

(21) Appl. No.: 10/097,809

(22) Filed: Mar. 13, 2002

(51) Int. Cl. B60Q 1/26

(52) U.S. Cl. 340/433; 340/686.1; 340/545.1

(57) ABSTRACT

An emergency exit monitor system for school buses provides both an audible and visual signal to the driver when one of the emergency exits is opened. The school bus comprises a plurality of emergency exits. One or more sensors detect when an emergency exit is open. A monitor communicates with the sensors and provides a visual and audible signal to the driver when a sensor detects an emergency exit is open. In one embodiment, the monitor additionally identifies which of the emergency exits are open.

### FIELD OF THE INVENTION

The present invention relates, in general, to exit monitors for vehicles, and more specifically to emergency exit monitors for school buses.

### BACKGROUND

Drivers of school buses have a demanding task. For example, drivers must care for a large number of students while at the same time maneuver a large vehicle, contend with traffic, bad weather and adverse road conditions. Complicating the driver's task, the driver must do all of this with their backs turned to the students who may become boisterous and unruly. Among all the responsibilities, the bus driver must also make sure that emergency exits are closed properly. For instance, during the initial start-up of the school bus, the driver should know which if any emergency exits are open or improperly latched. As a further example, on occasion children riding on a school bus will sometimes tamper with a latching mechanism or open one of the emergency exits. Due to the limited visibility from the driver's seat within a bus, coupled with the aforementioned demands on the driver's attention, the driver may be unaware that a child has opened an emergency exit or know which emergency exit was opened.

While prior art school bus alarm systems have addressed some of the problems of warning drivers of potentially dangerous situations involving children on a school bus, they have not addressed the problems to the extent of or in the manner of the present invention. Therefore, there is a continuing need for a system on a school bus to monitor emergency exits.

### SUMMARY

One example of the present invention is an emergency exit monitor system for a school bus. The school bus includes a roof, forward and rearward ends, left and right sides, a passenger door, a driver's seat and a plurality of passenger seats. A first emergency exit is on the rearward end of the bus, a second emergency exit is on the left side of the bus, and a third emergency exit is on the right side of the bus. Each of the emergency exits have an open position and a closed position and are operable for evacuating school bus passengers in the event of an emergency. The emergency exit monitor system has at least one sensor monitoring each of the emergency exits. Each sensor is operable for detecting when the corresponding emergency exit is in the open position. A monitor is in communication with the sensors and has individual indicators each corresponding to an emergency exit for providing a visual signal to the driver when a sensor detects that the corresponding emergency exit is in the open position. An audible alarm is in communication with the monitor and is operable to sound when a sensor detects that one of the emergency exits is in the open position.

Another example of the present invention is an emergency exit alarm system for a school bus. The school bus has a roof, forward and rearward ends, left and right sides, a passenger door, a driver's seat and a plurality of passenger seats. A plurality of emergency exits each have an open position and a closed position and are operable for evacuating school bus passengers in the event of an emergency. The emergency exits comprise a rear emergency exit located at the rearward end of the bus, a left emergency exit on the left side of the bus, a right emergency exit on the right side of the bus, and a roof emergency exit on the roof of the bus. At least one sensor monitors each of the emergency exits and is operable for detecting the position of each of the emergency exits. A monitor is in communication with the sensors and has individual indicators each corresponding to an emergency exit and being operable to provide a visual signal to the driver when a sensor detects that an emergency exit is in the open position. An audible alarm is operable to alert the driver when one of the emergency exits is opened. An electrical circuit electrically interconnects the sensor, monitor, audible alarm, and a power source, and is arranged to effect an armed state in which the alarm system is activated and a disarmed state in which the alarm system is deactivate.

Still another example of the present invention is an emergency exit alarm system for a school bus. The school bus has a roof, forward and rearward ends, left and right sides, a passenger door, a driver's seat and a plurality of passenger seats. A first, second and third emergency exit means are provided for evacuating school bus passengers out of the rear, left and right sides of the bus, respectively, in the event of an emergency. A means for detecting when one or more of the emergency exit means are open is provided. A means for visually indicating which emergency exit means is open is provided, said indicating means being in communication with the detecting means. A means for audibly signaling when at least one emergency exit means is open is provided.

Still other examples, features, aspects, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description taken in conjunction with the accompanying drawings, in which like reference numerals identify the same elements and in which:

FIG. 1 is a schematic view of a school bus having the emergency exit monitor system;

FIG. 2 illustrates an example of an emergency exit monitor circuit;

FIG. 3 illustrates an example of an emergency exit monitor system; and

FIG. 4 is a view of the front face of a monitor of an emergency exit monitor system.

### DETAILED DESCRIPTION

While the present invention is described hereafter with respect to emergency exit monitor systems for use on school buses, it should be understood that the present invention can be adapted for use on a variety of other vehicles. For example, emergency exit monitor systems would also be suitable for use on commercial buses, motor coaches, recreational vehicles, air planes, boats, and the like.

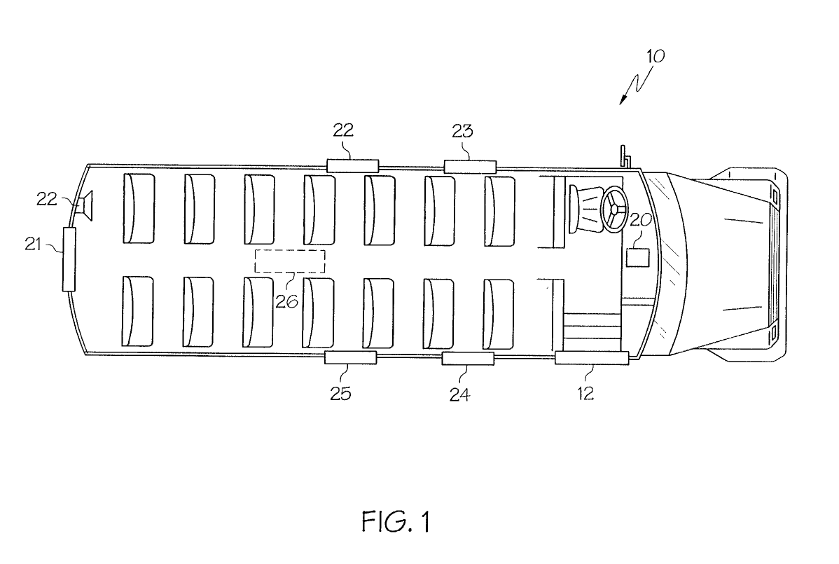

Referring now to the drawings in more detail and initially to FIG. 1, there is shown an example of an emergency exit monitor system which may be installed in school bus 10. In the present example, the school bus 10 includes a driver's seat, a plurality of passenger seats, and a front passenger door 12. The school bus 10 also comprises a plurality of emergency exits, which may take a variety of different forms known in the art, such as emergency exit doors, emergency exit windows, emergency exit panels, emergency exit hatches, and the like. Each emergency exit has an open position and a closed position and is operable for evacuating passengers from the school bus in the event of an emergency. In the closed position, the emergency exit is properly shut and latched (if the exit has a latching mechanism). In the open position, the emergency exit is not in the closed position. In the present example, the school bus 10 includes a rear emergency exit door 21, side emergency exit doors 22, 25, side emergency exit windows 23, 24, a top emergency exit hatch 26 on the roof (shown in phantom). While not a dedicated emergency exit, the front passenger door can also operate as an emergency exit. As will be readily appreciated by one with ordinary skill in the art, the number, location, type and combination of emergency exits can be varied from school bus to school bus, depending on a variety of design criteria and/or preferences. As such, more or less emergency exits may be employed and such exits may take any suitable form for allowing passengers to exit the school bus. For instance, the rear emergency exit door 21 could be replaced or complimented with a rear emergency exit window.

A plurality of the emergency exits have sensors to detect its position (i.e., whether the emergency exit is open or closed). In the present example, all emergency exits 21, 22, 23, 24, 25 and 26 each have a sensor, however, it is contemplated that only a portion of such exits have sensors. The sensors can monitor the exit itself and/or the latching mechanism (if one exists for that particular exit). The sensors in this example are electric switches mechanically operable with the emergency exit. When an exit is in the closed position the switch is open, and when an exit is in the open position the switch is closed. Alternatively, the emergency exit and switch relationship could be reversed. Beyond electric switches, the sensors can take a variety of other forms, such as magnetic sensors, optical sensors, or other sensors known in the art for detecting the position of a door, window or hatch.

The school bus 10 also includes a monitor 20. The monitor 20 is in communication with the various sensors. Such communication can be achieved directly or indirectly in a variety of ways known in the art, such as through electrical wires, radio frequency, optical signals, and the like. The monitor 20 includes a visual indicator to signal when an emergency exit is open. For instance, when a sensor detects that an emergency exit is in an open position, the monitor will provide a visual indication that the emergency is open. Optionally, the visual indicator will signal which of the emergency exits are open. While the monitor 20 can be positioned in a variety of locations within the school bus 10, in the present example the monitor 20 is positioned in location where it can be seen conveniently by the driver while seated in the driver's seat, such as the dashboard. Optionally, an audible signal 22 cooperates with the monitor 20 such that when a sensor detects that an emergency exit is open, the audible signal will sound. The audible signal 22 can take a variety of forms including, for example, buzzers, horns, the bus horn, alarms, solid state piezoelectric buzzers, and other mechanisms know in the art for creating audible signals. Preferably, the audible signal 22 will have sufficient volume such that the driver can hear the signal while seated at the driver's seat during normal operating conditions of the bus.

In one example, the monitor 20 has an armed state and a disarmed state. For instance, the monitor 20 will be armed when the ignition is in the on position and disarmed when the ignition is in the off position. In the armed state the monitor 20 and audible signal 22 will operate as described above, however, in the disarmed state neither the monitor 20 nor the audible signal 22 will function in response to the sensors.

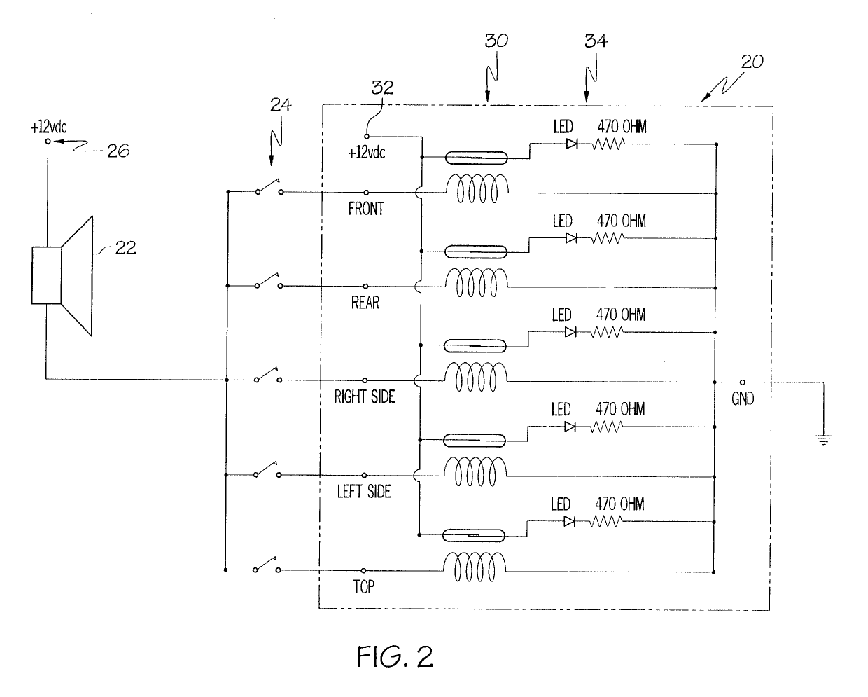

FIG. 2 illustrates an example of a circuit design for an emergency exit monitor system. A plurality of sensors 24, shown here as electric switches, each correspond to an emergency exit on a school bus. In this example, the sensors 24 correspond to the front door, rear emergency exit, right side emergency exit, left side emergency exit, and top emergency exit. When an exit is in its closed position, the corresponding sensor 24 is open. When an emergency exit is in its open position, the sensor 24 is closed, thus allowing electric current to flow from the power source 26 to ground and the audible signal 22 is activated. Each sensor 24 also has a corresponding relay 30. When a sensor circuit is closed, the corresponding relay 30 closes a circuit from the power source 32 to ground thus activating the LED 34 to provide a visual indication as to which exit is open. When a sensor circuit is open, the corresponding relay 30 is also open and the LED 34 is not activated. As will be readily appreciated by one with ordinary skill in the art, a variety of alternatives circuit designs may also be employed to achieve the same or similar functionality as the present example. Optionally, the power source 26 and/or power source 32 are not activated unless the ignition to the school bus is in its on position.

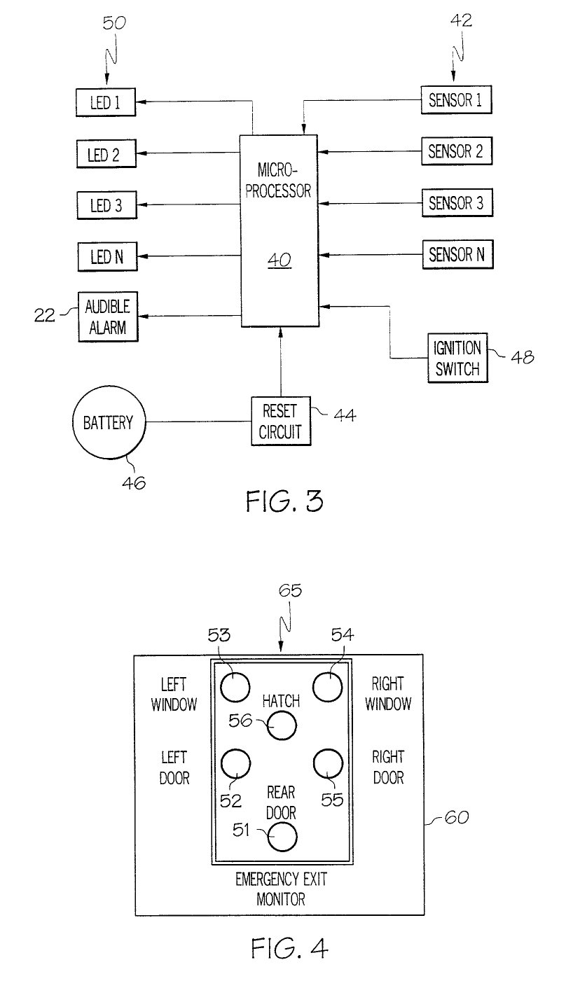

Referring to FIG. 3, a schematic diagram showing in general terms another example of an emergency exit monitor system for a school bus. The alarm system includes sensors 42, an audible alarm 22, indicator LEDs 50, a microprocessor 40, a reset circuit 44, and a power source 46. The sensors 42 monitor with each of the emergency exits on the school bus for detecting the position of the emergency exits. The sensors 42 are designed to interface with the emergency exits in order to trip when one of the exits of the school bus has been opened. In this example, each sensor 42 has a corresponding indicator LED 50. The power source 46 comprises a battery preferably in the range of from about 7 v to about 32 v, however, one skilled in the art would recognize that any suitable power source may be used with equal facility. The reset circuit 44 ensures that the microprocessor 40 powers up correctly when voltage is first applied by the power source 46. In one embodiment, the microprocessor 40 is a low power microcontroller programmed to scan the sensors 42, and if a sensor 42 is tripped the microcontroller drives the audible alarm 22 and the indicator LED 50 that corresponds to the tripped sensor 42. Optionally, the microprocessor 40 is programmed such that the indicator LED 50 will remain on for a predetermined period of time (e.g. 30 seconds) after the sensor 42 detects the emergency exit is closed, thus providing the driver enough time to determine which emergency exit had been opened.

FIG. 4 illustrates an example of a panel 60 for a monitor 20. As shown in this example, the panel 60 is generally rectangular in shape and may be positioned in the dashboard of the school bus 10. The panel 60 includes individual indicators 51, 52, 53, 54, 55 and 56 each corresponding to an emergency exit. Preferably, the individual indicators comprise light emitting diodes (LEDs) of any suitable color, however, one skilled in the art will recognize that any suitable indicator capable of providing a visual signal to the driver when an emergency exit is opened may be used with equal facility. For example, the visual indicator can take the form of incandescent bulbs, liquid crystal displays, or other ways known in the art.

As shown in the embodiment of FIG. 4, the panel 60 comprises a visual representation 65 of a school bus 10. As shown in this example, the representation is a rectangular shape that provides a simplified and abstract representation of the school bus. The six indicators 51, 52, 53, 54, 55 and 56 are arranged relative to the visual representation 65 to indicate to the location of each of the emergency exits on the bus. For example, indicators 51, 52, 53, 54, 55 and 56 correspond to emergency exits 21, 22, 23, 24, 25 and 26, respectively. The present example also includes text labels for each of the indicators 51, 52, 53, 54, 55 and 56. As shown here, the text labels include “REAR DOOR”, “LEFT DOOR”, “LEFT WINDOW”, “RIGHT WINDOW”, “RIGHT DOOR”, and “HATCH,” however, other textual descriptions may also be employed. One with ordinary skill in the art will readily recognize that the configuration, designation and number of emergency exit indicators can be varied depending on the sensor and emergency exit configuration of the school bus.

Having shown and described various embodiments of the present invention, further adaptations of the emergency exit monitor system described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

What is claimed is:

1. An emergency exit monitor system for a school bus having a roof, forward and rearward ends, left and right sides, a passenger door, a driver's seat and a plurality of passenger seats, a first emergency exit located on the rearward end of the bus, said first emergency exit having an open position and a closed position and being operable for evacuating school bus passengers in the event of an emergency, a second emergency exit on the left side of the bus, said second emergency exit having an open position and a closed position and being operable for evacuating school bus passengers in the event of an emergency, and a third emergency exit on the right side of the bus, said third emergency exit having an open position and a closed position and being operable for evacuating school bus passengers in the event of an emergency, the system comprising:
(a) at least one sensor monitoring each of the emergency exits, each of said sensors being operable for detecting when the corresponding emergency exit is in the open position;
(b) a monitor in communication with the sensors, the monitor having individual indicators each corresponding to an emergency exit for providing a visual signal to the driver when a sensor detects that the corresponding emergency exit is in the open position; and
(c) an audible alarm in communication with the monitor and being operable to sound when a sensor detects that one of the emergency exits is in the open position.

2. The system according to claim 1, wherein the emergency exits are selected from a group consisting of an emergency exit door, emergency exit window, emergency exit hatch, and emergency exit panel.

3. The system according to claim 1, further comprising a fourth emergency exit on the roof of the bus, said fourth emergency having an open position and a closed position and being operable for evacuating school bus passengers in the event of an emergency.

4. The system according to claim 1, wherein the indicators are positioned in a location which can be seen conveniently by the driver while seated in the driver's seat.

5. The system according to claim 1, wherein the monitor comprises a visual representation of the school bus and the indicators are positioned relative to the representation of the school bus to indicate the corresponding emergency exit.

6. The system of claim 5, wherein the indicators are light emitting diodes.

7. The system according to claim 1, wherein each indicator is labeled with text describing the corresponding emergency exit.

8. The system according to claim 1, further comprising an electrical circuit interconnecting the sensors, monitor and audible alarm.

9. The system according to claim 8, wherein the electrical circuit is arranged to effect an armed state and a disarmed state.

10. The system according to claim 9, wherein the circuit is in the armed state when the ignition is in the on position and the circuit is in the disarmed state when the ignition is in the off position.

11. The system according to claim 8, wherein at least a portion of the electrical circuit is a microprocessor.

12. The system according to claim 1, wherein the audible alarm comprise a buzzer.

13. The system according to claim 1, wherein at least one of the emergency exits has a latching mechanism.

14. An emergency exit alarm system for a school bus having a roof, forward and rearward ends, left and right sides, a passenger door, a driver's seat and a plurality of passenger seats, the system comprising:
(a) a plurality of emergency exits each having an open position and a closed position and being operable for evacuating school bus passengers in the event of an emergency, said emergency exits comprising:
i) a rear emergency exit located on the rearward end of the bus;
ii) a left emergency exit on the left side of the bus;
iii) a right emergency exit on the right side of the bus; and
iv) a roof emergency exit on the roof of the bus;
(b) at least one sensor monitoring each of said emergency exits and being operable for detecting the position of each of the emergency exits;
(c) a monitor in communication with the sensors, the monitor having individual indicators each corresponding to an emergency exit and being operable to provide a visual signal to the driver when a sensor detects that an emergency exit is in the open position;
(d) an audible alarm operable to alert the driver when one of the emergency exits is opened;
(e) a power source; and
(f) an electrical circuit electrically interconnecting the sensor, monitor, audible alarm, and power source and arranged to effect an armed state in which the alarm system is activated, and a disarmed state in which the alarm system is deactivate.

15. The system according to claim 14, wherein the emergency exits are selected from a group consisting of an emergency exit door, emergency exit window, emergency exit hatch, and emergency exit panel.

16. The system according to claim 14, wherein the school bus further comprises one or more additional emergency exits that do not have corresponding sensors.

17. The system according to claim 14, wherein each indicator is labeled with text describing the corresponding emergency exit.

18. The system according to claim 14, wherein the monitor comprises a visual representation of the school bus and the indicators are positioned relative to the representation of the school bus to indicate the corresponding emergency exit.

19. An emergency exit alarm system for a school bus having a roof, forward and rearward ends, left and right sides, a passenger door, a driver's seat and a plurality of passenger seats, the system comprising:
(a) a first emergency exit means for evacuating school bus passengers out of the rear of the bus in the event of an emergency;
(b) a second emergency exit means for evacuating school bus passengers out of the left side of the bus in the event of an emergency;
(c) a third emergency exit means for evacuating school bus passengers out of the right side of the bus in the event of an emergency;
(d) a means for detecting when one or more of the emergency exit means are open;
(e) a means for visually indicating which emergency exit means is open, said indicating means being in communication with the detecting means; and
(f) a means for audibly signaling when at least one emergency exit means is open.
